(19) United States
(12) Patent Application Publication
(10) Pub. No.: US 2009/0265258 A1
(43) Pub. Date: Oct. 22, 2009

(54) Bag Tracking System and Bag Counting Rack Associated Therewith

(76) Inventor: Joseph T. Regard, Madisonville, LA (US)

Correspondence Address: JOSEPH T. REGARD, LTD PLC, PO DRAWER 429, MADISONVILLE, LA, 70447-0429, US

(21) Appl. No.: 12/477,533

(22) Filed: Jun. 3, 2009

Related U.S. Application Data
(63) Continuation of application No. 11/778,057, filed on Jul. 15, 2007.
Application No. 11/778,057 is a continuation-in-part of application No. 11/053,317, filed on Feb. 7, 2005, now Pat. No. 7,248,164.
(60) Provisional application No. 60/867,422, filed on Nov. 28, 2006.

(51) Int. Cl. G06Q 10/00; G01G 19/00

(52) U.S. Cl. 705/28; 186/66

(57) ABSTRACT

A sensor-based bag counting system for monitoring bag use at a check out stand or the like. The preferred embodiment teaches a scale, pressure switch, or like sensor unit which integrates with a bag rack to sense the load generated by a bag as it is loaded and use same to count the bags at they are removed from the rack, and compile data including the number of bags per customer per transaction, the average amount or product per bag, the amount of bags packed overweight or underweight, and other data which can be used to for instructional purposes, monitor bag usage, or calculate the deposit to be charged the customer for the bags used, for example. tracking, managing, dispensing and recycling bags, particularly retail and grocery-type bags such as t-shirt bags and the like. An RFID based bag monitoring and management system is also disclosed. An alternative system contemplates a sensor which Lastly, the present invention contemplates a recycling bin which incorporates an RFID scanner to scan a collection of bags simultaneously as they are returned by the user, utilizing the data to calculate a refund due the customer.

### DOMESTIC PRIORITY DATA AS CLAIMED BY APPLICANT

The present application is a continuation of U.S. Utility patent application Ser. No. 11/778,057 filed Jul. 15, 2007 entitled “Bag tracking system and bag counting rack associated therewith”, which '057 application claims the benefit of Provisional Application 60/867,422 filed Nov. 28, 2006 entitled “Bag Rack Sensor and Display System”, which '057 application is also a continuation in part of U.S. patent application Ser. No. 11/053,317 filed Feb. 7, 2005, U.S. Pat. No. 7,248,164 entitled “Radio Frequency Identification Bag Tracking and Recycling System, and Bag Counting Rack Associated Therewith”.

### TECHNICAL FIELD OF THE INVENTION

The present invention relates to a sensor unit which is configured to interface with a grocery bag rack or the like to provide real time data to the operator including bag count per customer, bag count per operator, product count per bag, average weight of bag contents, as well as feedback relating to optimal bag content weight.

The present invention also relates to radio frequency identification (RFID) technologies, and in particular to an RFID-based system for tracking, managing, dispensing and recycling bags, particularly retail and grocery-type bags such as t-shirt bags and the like.

The preferred embodiment of the present invention contemplates a system wherein there is employed at a T-Shirt bag fabrication facility an RFID tag dispensing system configured to affix or otherwise incorporate an RFID tag to the thermoplastic film utilized in forming a T-shirt bag, which bag is formed into a stack.

The RFID tag is associated with the bag at the time of manufacture, and information pertaining to said bag is saved in a central computer, which is subsequently used in shipping and management of the bag(s).

A sensor bag rack is provided for supporting the bag pack during dispensing and use of the bags at the checkout counter, which supports the bag during loading and is configured to relay data on said bag as it is removed from the rack for placement in the customers cart, or otherwise provided to the customer.

An alternative embodiment of the bag rack of the present invention contemplates a sensor which counts the bags at they are removed from the rack and compiles the number of bags per customer per transaction, which can be used to monitor operator performance (such as for verification of proper filling of the bags by the operator) and bag usage, as well as to calculate any deposit which might be charged to the customer for the bags used.

Data on the number of bags used in bagging of the customers goods is thereby provided, which maybe used to calculate a deposit for each bag, which is charged to the customer. The customer may also be associated with each bag for compiling subsequent data on recycling of said bags.

Lastly, the present invention contemplates a separate recycling bin which incorporates an RFID scanner to scan a collection of bags simultaneously as they are returned by the user, utilizing the data to calculate a refund due the customer.

### BACKGROUND OF THE INVENTION

The use of RFID tags has significantly increased recently, as costs of the tags and associated equipment has plummeted. Radio Frequency Identification (RFID) tags are used to track products, as well as other uses such as toll tags and animal identification.

A typical RFID tag requires no battery as it utilizes the energy of the scanner, the tag acting as a transponder to relay generally basic identification information, which information is used for tracking via a central computer.

On another front, with enhanced environmental awareness, local and regional governments have discussed implementing deposits on thermoplastic grocery bags or the like, to raise revenues as well as discourage littering, while encouraging recycling.

However, a typical customer can utilize literally dozens of bags every month, typically placing the bags in one of the bags. Thus many of the grocery bags can be stuffed in a single bag. By the time a customer gets to a recycling area to return the bags, there may be literally hundreds of bags stuffed in several of the bags.

It would not be cost or time effective for an employee of the recipient of the bags to sort through and count each bag in the collection of bags returned. Further, the deposit to be returned to the customer must be calculated and refunded to the client. Also, the deposit for the bag may vary depending upon the jurisdiction and use, and there is no easy, fast, cost effective means of determining the deposit paid upon the bag. A jurisdiction refunding a fixed deposit price on all t-shirt bags could find itself paying monies under the guise of deposit refunds on bags which had not deposit paid thereon, or bags which had a lesser deposit paid than the intended bags for that jurisdiction.

It is believed there is no automated system for receiving, counting, identifying, calculating, and refunding the deposit, thus at this point a deposit return scheme is believed impractical due to the operational costs utilizing the above discussed manual, non-automated techniques.

### GENERAL SUMMARY OF INVENTION

Unlike the prior art, the present invention provides an automated means of tracking t-shirt grocery bags from manufacture to recycling, providing a system for calculating deposits on the bags during a retail transaction utilizing said bags, and providing an automated means to receive, count, calculate and refund to the customer said deposit, while providing information on said customer.

In the exemplary embodiment of the present invention, an RFID tag dispensing device affixes an RFID tag on a length of plastic film utilized to form a t-shirt bag, the bag collected with other bags and formed into a bag stack, which is then packed for shipping. Data on the bags is then compiled into a central computer, which may relay said data to the store for subsequent use.

The bags are then received by the store warehouse, where they may be tracked via the RFID tags for storage and subsequent retrieval when ready for use, at which time said stacks of bags are provided to the check-out stand associated with the store.

The bag stacks are placed upon a rack, where the bag on the top (now forward) portion of the stack is individually filled. A sensor associated with the rack scans the RFID tag on said bag and associates said bag with the customer. Each bag removed from the rack during customer checkout is associated with said customer, said data used, among other things, to compute the amount of deposit to be charged to the customer, which is added to the receipt and charged to the customer at the completion of checkout.

A non-RFID rack of the present invention utilizes a sensor such as, for example, a weight sensor or pressure sensor or switch associated with the base of the rack (specifically referenced in my earlier '317 application), which may be configured to count, via computer, bags removed from the rack, for monitoring proper filling of the bags by the party operating the checkout counter, as well as monitoring bag use efficiency and/or for calculating total deposit to be charged to the customer. “Proper filling of the bags” is known to involve monitoring the load weight of each loaded bag (and whether each bag is loaded within its optimal load capacity), as well as the total amount of bags utilized in a transaction. It can also be important to know the amount and/or type of items loaded in a bag. An exemplary embodiment of the non-RFID rack of the present invention is disclosed which utilizes as the pressure sensor or switch, a load cell associated with the base of the rack. Once again, this system does not rely upon RFID tags for discerning the removal and use of the bag. Alternatively, a switch associated with the support arm of the rack, a proximity switch, or other means to discern removal of a bag from the rack (of which there are several) may be utilized.

Accordingly, the preferred embodiment teaches a scale, pressure switch, or like sensor unit which integrates with a bag rack to sense the load generated by a bag as it is loaded and use same to count the bags at they are removed from the rack, and compile data including, for example, the number of bags per customer per transaction, the average amount or product per bag, the amount of bags packed overweight or underweight, and other data which can be used to for instructional purposes, monitor bag usage, or calculate the deposit to be charged the customer for the bags used, for example. tracking, managing, dispensing and recycling bags, particularly retail and grocery-type bags such as t-shirt bags and the like.

The above non-RFID sensor rack can be used to count the amount of bags for calculation of deposit. However, as RFID is not used, a non-RFID verification means would be preferable to prevent fraud, and a bar code or other indicator could be printed upon the bag identifying the bag and verifying the source. Under such a scheme, each bag would ideally have its own proprietary bar code for ID purposes, to verify refund of deposit for that particular bag, in a bag tracking scheme. This would avoid the problem of having to pay for deposit refunds on bags where no deposit was actually paid in that jurisdiction, and verify the correct deposit to be paid.

However, even with a bar code scheme, each bag would have to be individually scanned, which once again presents a time and labor dilemma, once again reiterating the need for a scanning option which would allow scanning of crumpled up bags stuffed, in plurality, in a single bag.

Thus, in the preferred, RFID embodiment of the present system, an automated recycling bin system is also provided in the present system, wherein there is provided a container for receiving a bulk amount of uncounted bags having RFID tags thereon, container configured to scan and automatically count each bag in the bulk of bags, discerning data on the bags including deposit information, which is used to calculate a deposit refund for refunding to the customer.

The present system thereby provides an automated system for tracking and recycling of bags which is entirely automated and which is reliable, cost effective, and environmentally sound.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1 is a flow chart illustrating the method of the preferred embodiment of the present invention.

FIG. 2 is a side view of an exemplary embodiment of an RFID tag dispensing system for dispensing and affixing an RFID tag to a length of plastic film.

FIG. 3 is an isometric view of the upper, receiving area of a recycling container, illustrating the lid being lifted and a collection of bags within a bag being placed therein.

FIG. 4 is aside view of the recycling container of FIG. 3, illustrating scanner means being utilized to scan, count, and discern data on the number and identity of the bags within the receiving area.

FIG. 5 is a side view of the recycling container of FIGS. 2 and 3, illustrating the false bottom of the receiving area opening to allow the scanned bags to be collected in a bin or the like.

FIG. 6 is an isometric view of the preferred bag rack of the present invention, wherein there is provided a sensor in the base, which may be in the form of an RFID scanner, weight, proximity, movement, or other sensor for detecting removal of a loaded bag from the rack.

FIG. 7 is a generally side, isometric view of the an alternative embodiment of the rack of FIG. 6, illustrating a pressure or weight sensor in the form of a strain gauge situated within a low profile sensor platform associated with the base of a bag rack, below the bagging area of the rack, and a display console in the vicinity of said base.

FIG. 8 is an isometric view of the invention of FIG. 7, illustrating in phantom a bag opened on the rack for filling.

FIG. 9 is an isometric view of the invention of FIG. 8, illustrating product loaded in the bag, with the display indicating bag count, weight, and total bags used.

FIG. 10 is an isometric view of the sensor platform and the repositionable display unit situated adjacent thereto.

FIG. 11 is an isometric view of the display unit of FIG. 10.

FIG. 12 is an isometric view of the scale of FIG. 12, with the partition bracket of FIG. 15 installed to segregate the bag pack from the bag being loaded.

FIG. 13 is an isometric view of the invention of FIG. 12, illustrating an open bag for loading, and the bag pack being segregated from said opened bag by the partition bracket.

FIG. 14 is an isometric view of the sensor platform and display unit of FIG. 13, illustrating the configuration and placement of the partition bracket, with only the rack base of the rack being shown.

FIG. 15 is an isometric view of the partition bracket of FIG. 14.

FIG. 16 is a side view of an alternative display panel for use with the invention of FIGS. 7-14, illustrating a gooseneck support for alternative positioning of the control panel about the sensor platform to accommodate various configuration racks and installations.

### DETAILED DISCUSSION OF THE INVENTION

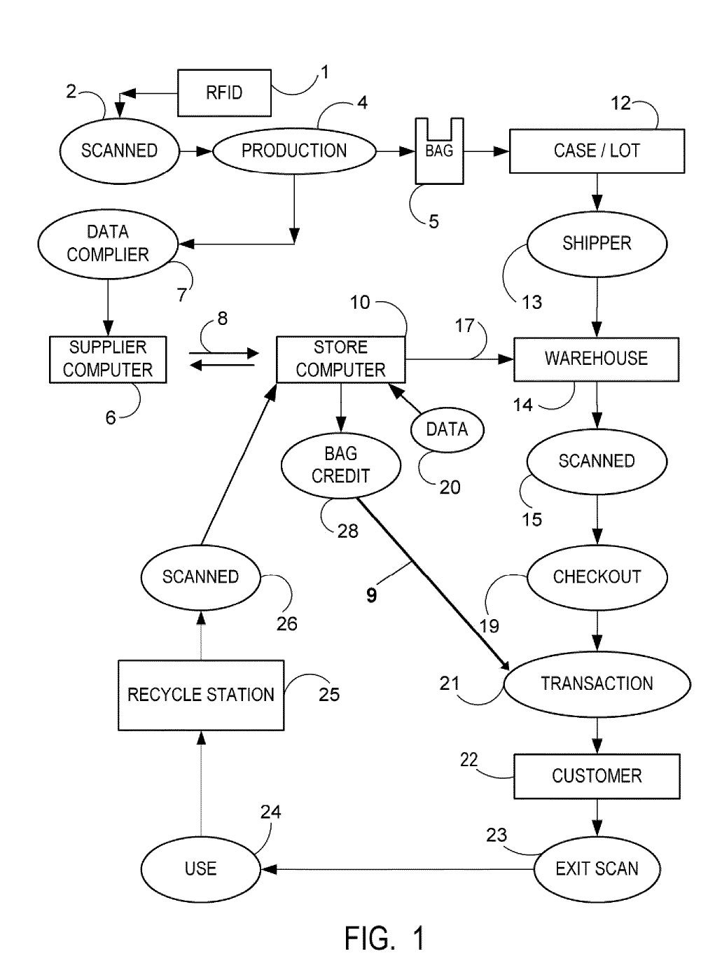

Referring to FIG. 1 of the drawings, radio frequency ID Tag 1 having a unique code (ID tag number) is scanned 2 by an RFID scanner to determine the id tag number.

The RFID tag is preferably physically formed with (i.e., incorporated into the film) or attached (i.e., by heat melt welding, adhesive, or other adhesion means) to a bag 5 during production 4. Production data 3 on the formed bag 5 is then compiled 7, which includes the id tag number associated with the bag as well as other data, which may include lot information derived from other sources, including customer, date of manufacture, specifications, projected date of delivery, date of projected use, store location or other instructions by the store, manifest data, so as to provide bag data, which bag data is directed to, processed by, and stored on the supplier computer 6 (the compiler can be part of said computer). The bag data is then communicated 8 to the store computer 10 (the entity or an affiliate thereof utilizing the bags in the retail operation), for retrieval 17 by the store warehouse 11.

At the production facility, the bag 5 is processed into a case or lot 12, which is shipped 13 via shipper to the store warehouse 14, where may be remotely scanned 15 (without removal from its packing), to retrieve the RFID tag numbers, which numbers are associated with the bag data retrieved 17 from the store computer, and warehouse information including the bag data which can include verification inventory of the received bags, actual date time of delivery, receiver, storage location, condition, etc can be sent 16 to the store computer 10 to be associated with the bag data and appended to same for subsequent use and retrieval as required.

Information retrieved 17 from the store computer is then used by the warehouse to supply bags 18 to the retail checkout stations for use during checkout 19, preferably utilizing just in time supplier techniques.

After the bags have been supplied to the checkout station, during checkout 19, the cashier packs goods in each bag, often individually, which bag may be scanned as it is removed from the bagging area and placed in the grocery cart. The scanner may be associated with the bag rack and be initiated as the bag is removed form the rack via proximity sensors or switches (see FIG. 6), or it may be actuated by placing the bag upon a counter surface prior to placing in the grocery cart. Alternatively, the bag may be scanned as it is placed in the cart.

Transaction data 20 on the amount of bags used to complete checkout, as well as other possible data, including the customer identity where available, is sent to the store computer 10, which determines any possible surcharges or credits, including possible deposits fees on the amount of bags used, which additional fees and/or credit(s) 28 are sent to be added 9 to the transaction 21 for a final transaction tally, comprising the price of the goods with taxes, plus the automated calculation by computer of the deposit charge for bags used in the transaction, less credit for bags returned for deposit, which is paid by the customer 22. In addition to the scanner scanning the bag as it is removed from the rack, the contents of each scanned bag can be tracked for security and verification of proper filling of the bags by the party operating the checkout counter.

After the transaction 21 has occurred (i.e. the customer has authorized payment or otherwise has become obliged to pay the store or vendor), the customer 22 receives the cart with the bags and product, which may then be scanned one last time at the exit 23 of the establishment for security purposes, as it indicates when the customer left the store, as well as the number of bags in the cart.

The cart may have an RFID tag as well identifying when the cart entered the store, the path it took about the store (via an array of RFID sensors situated about the store), and when it left the store for marketing, customer profile, and security information, which information can be associated with the customer upon identification of the customer, typically at the transaction 21.

The bags are then removed by the customer from the area, and used 24 to convey the bags to the customer destination. Once used, the bags may be consolidated into a one or more bags, and are taken to a-recycle station 25, which may be at the store. The bags are scanned 26 at the recycle station, which determines the ID tag number for each bag, which is associated with the bag information on the store computer 10 to determine a bag credit 28, which is applied at the customer's next transaction 21 at the store during checkout 19. Alternatively, the bag credit can be paid to the customer by the store, or a credit can be applied to an account (i.e., credit card, bank account) as indicated by the customer.

FIGS. 3-5 illustrate an embodiment of the recycle station of the present invention. In use, the customer places 50 a quantity of bags 51 (which can comprise a plurality of bags 52 situated in a disorganized fashion within or more bags) in an receiving bin 53. The bin 53 may have an interior space 53′ sized to accommodate a pre-determined amount of bags, to insure operation within the scanner's capabilities, or maintain the bag lots being scanned within criteria established for the recycling operation.

A lid 54 may be provided which may have a switch associated therewith to initiate the system upon closing 55 of the lid with the bags therein. An RFID scan 56 of the contents of the upper bin is then made to discern the ID tag numbers of each bag is then made (FIG. 4) and the total number of RFID tags within the receiving bin to calculate the total number of verifiable bags within the bin.

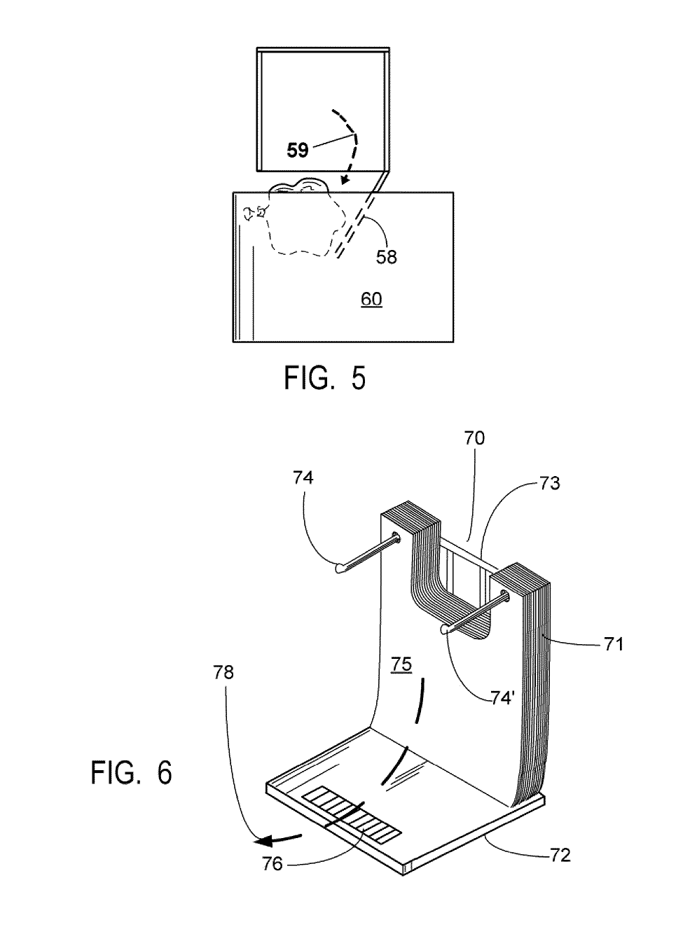

This scan can be initiated by a button or switch initiated by the user, as indicated, by the act of closing the lid, or via proximity sensor. Once the scan 56 has completed, and the transponder or RFID data 57 received, the bottom of the upper bin can be formed to open 58 to allow the bags to fall 59 through to a lower storage area 60 (FIG. 5). The storage area may be in the form of a lower storage bin (not shown) for storage of the scanned, returned bags.

Alternatively, a chute, conveyor or modular, wheeled bin may be used to store the returned bags.

Once scanned, an indicator light or other means such as visual or audio indicia is provided to indicate to the customer that the scan has been completed. Other indicia, including a printed receipt or message display 60 can be provided to indicate to the customer transaction information. The receipt may include, for example, a bar code which could be utilized to apply a credit for any returned deposit on the bags, or obtain a refund on same.

As an alternative to a trap door or other automated removal of the bags from the receiving bin, a confirmation light, sound, display, or other indicia can be initiated to inform the bin operator that the scan has been completed, at which point the scanned bags can be removed from the recycling bin, to be placed in a collection or storage area.

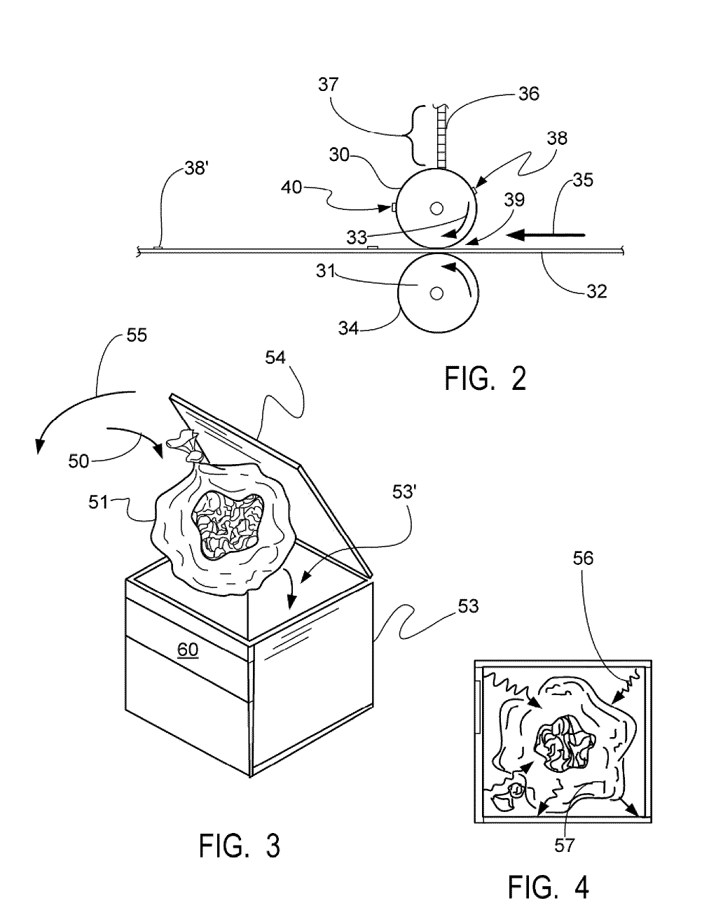

FIG. 2 indicates an example of a device to apply the RFID tag to the film web used to form the bag. As shown, upper 30 and lower 31 rollers, which can be rollers situated in the vicinity of the bubble extrusion device to form the film, have a film web 32 running therebetween, such that the rollers rotate 33, 34 with the progression 35 of the film therethrough. A dispenser 36 in the form of a slotted, gravity or spring fed magazine or the like having a plurality of RFID tags 37 situated therein sequentially deposits a tag 38 on the drum as it rotates, which tag is engaged to the film web as it passes between 39 the rollers.

The tag is positioned and spaced on the film web such that subsequent cut-out and forming of the bag by the bag making machine includes preferably a single RFID tag thereon in a generally uniform position, for example, the side gusset or bottom of the bag.

The dispenser may be triggered to deposit the single RFID on the film web by a notch or tooth 40 situated upon the drum, or by a mark upon the drum with sensor associated with the dispenser 36, or via communication with the device driving rollers 33,34. The sensor 38′ may be pressure fused to the film 32 by its passing through the rollers, may be heat applied to the film, or may utilize adhesive or other means known in the art.

It is further anticipated that the rollers 30, 31 can be part of a printer drum assembly, and be driven by a printer, such that the RFID tags are applied to the film at the time of the printing of the film used to form the bags. It is also anticipated that an alternative means of attachment of the RFID tags utilizing the printer drums could entail mixing the RFID tag with the ink and applying the tag via the ink to the film as part of the printing process.

Alternative RFID application devices could be associated with the bag cut-out machine, the bag pack forming machine, or the like.

Further, heat resistant RFID tags could be mixed with the resin prior to film formation, and extruded with the resin via bubble extruder to the like such that the RFID tag is embedded into the film web.

FIG. 6 illustrates an exemplary bag rack 70 for supporting a pack or stack of bags 71, the rack having a base 72 and vertical support 73, the vertical support having generally horizontally disposed, spaced horizontal support members 74, 74′ for supporting the stack of bags 71. A sensor 76 is provided to detect an RFID tag in its immediate vicinity, for example, within 0-4 inches therefrom.

In use, the next bag 75 to be dispensed from the stack is typically opened on the rack and filled, then removed 78 from the rack, in the process dragging or maneuvering the bottom of the bag over the sensor 76, which detects the RFID tag 77 affixed to each bag, in the present example, preferably in the lower region of the bag. The sensor then communicates the information on the RFID tag to the store computer, which is associated with the ongoing transaction and may be used to calculate a deposit surcharge or other use as disclosed supra.

As discussed earlier in this application, an embodiment of the present invention which would not require RFID tags or sensors can utilize a sensor 76 comprising a pressure switch or the like (which may likewise be positioned at the base 72 of the rack 70), to detect removal of the filled bag 75 from the rack, which data is communicated to the computer (10 in FIG. 1) to allow the system to compile the number of bags per customer per transaction. Accordingly, this alternative system, like the previous embodiment, likewise provides a means of counting the bags as they are removed from the rack, and compiling the number of bags used per customer per transaction.

In use, the next bag 75 to be dispensed from the stack is opened on the rack and filled, then removed 78 from the rack, in the process dragging or maneuvering the bottom of the bag over the sensor 76, which detects the filled bag, and communicates that detection to the computer, which is used to provide a bag count associated with the transaction, or other use as disclosed herein. Said count may be used, for example, to calculate total deposit to be charged to the customer for bags used, or, for verification of proper filling of the bags by the party operating the checkout counter.

Other sensors which may be utilized in this capacity could include, for example, a proximity switch, a weight sensor, a switch associated with the support arm on the rack, or other means to discern removal of a bag from the rack (of which there are several), which is counted by a computer.

A summary of a method utilizing the above non-RFID embodiment may comprise, for example:

A method of determining the amount of grocery bags utilized in a retail transaction, comprising the steps of:

a) providing a bag stack comprising a plurality of bags removably affixed to one another in uniform registration,

b) providing a bag rack comprising a base and a vertical support, said base having associated therewith a sensor;

c) mounting said bag stack upon said bag rack such that said bag stack is supported in substantially vertical orientation by said rack;

d) opening a bag from said bag stack upon said rack, and placing product therein, providing a filled bag;

d) removing said filled bag from said rack; while

e) utilizing said sensor to detect said bag as it is removed from said rack, so as to provide sensor detection;

f) communicating said sensor detection to a computer, said computer utilizing said sensor detection to count said bag, so as to provide a bag count;

g) repeating steps b-f until said retail transaction is complete, providing a final bag count; and

h) associating said final bag count with said transaction.

As discussed above, as well as in my previous application Ser. No. 11/053,317, the above referenced sensor need not comprise an RFID sensor and may comprise a weight sensor or a pressure switch or the like associated with the base of the rack. Other sensor means such as a proximity switch are described.

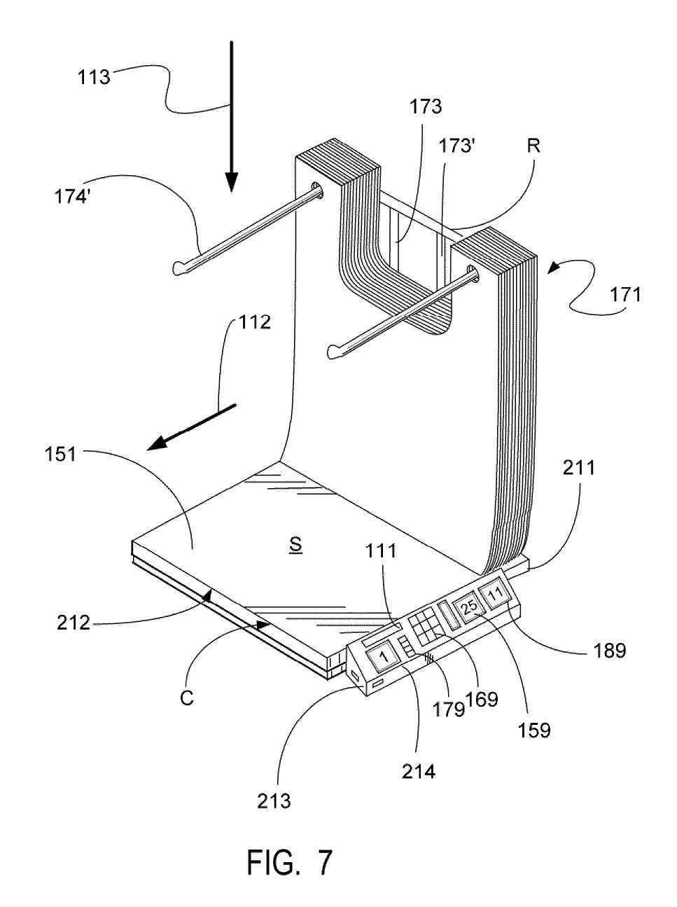

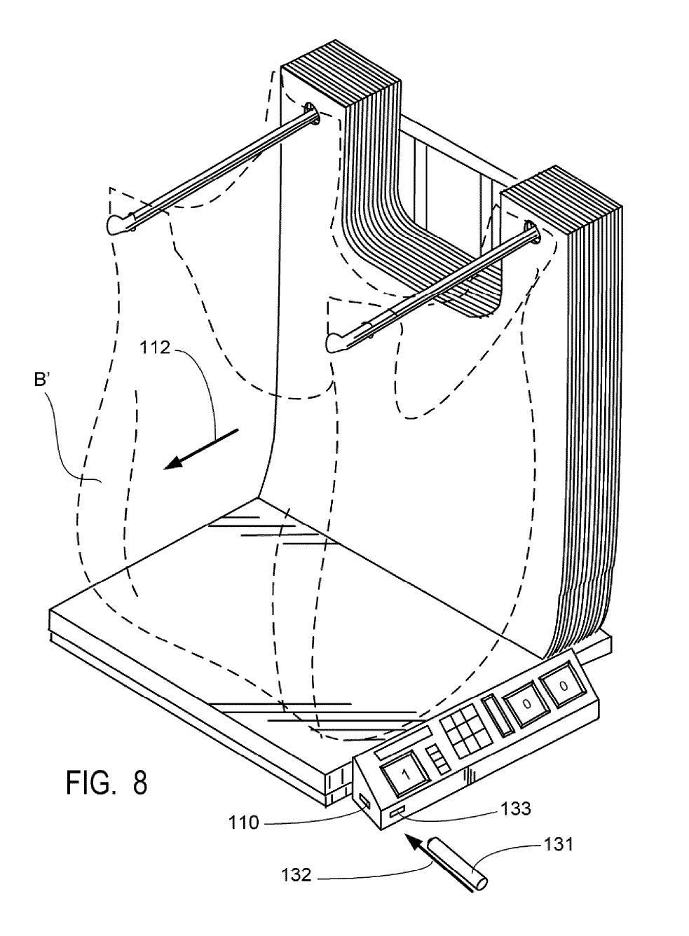

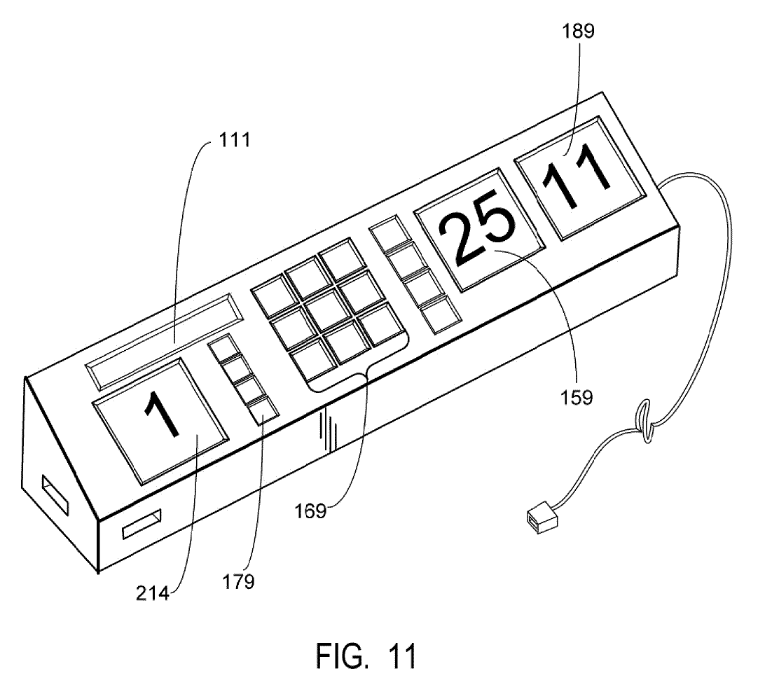

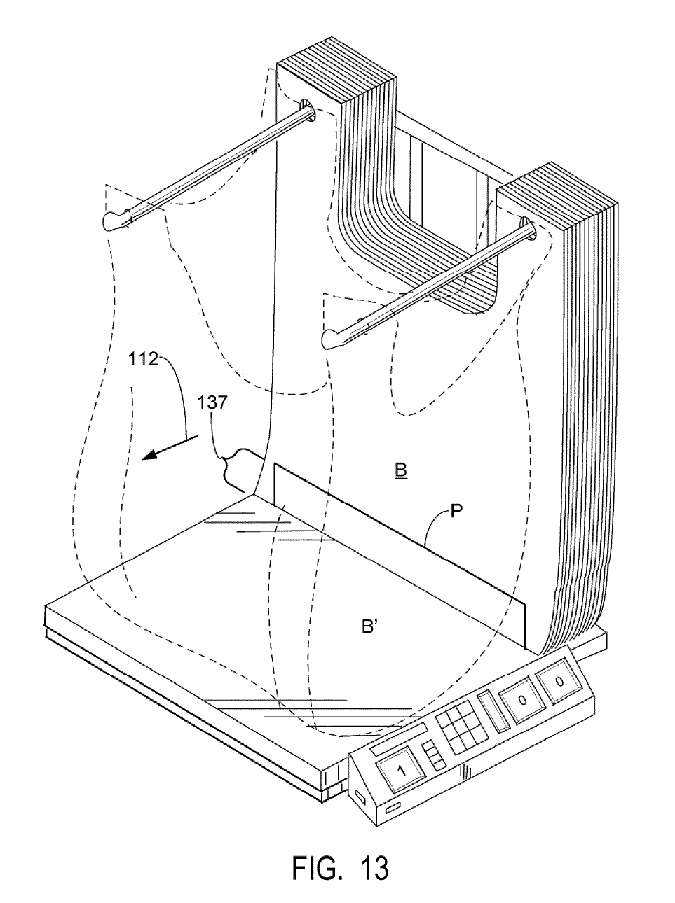

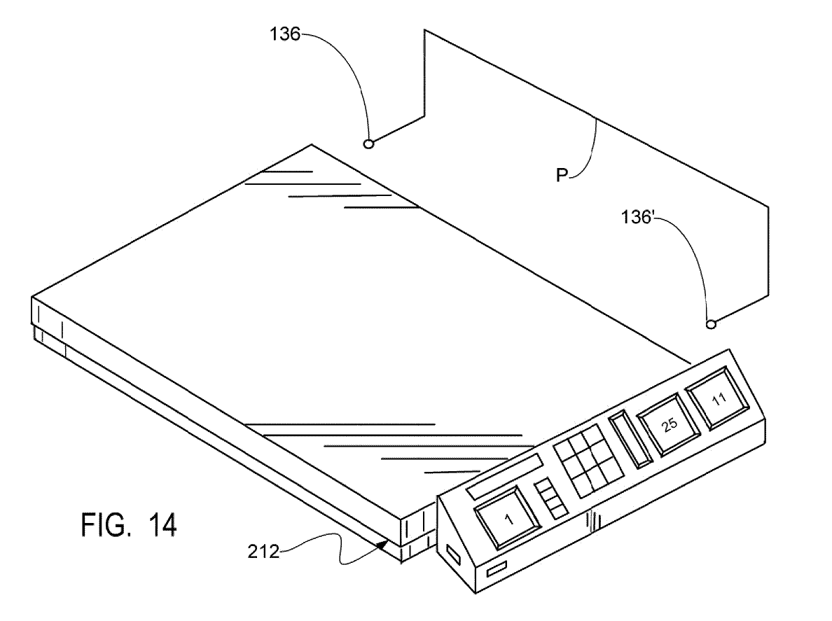

FIGS. 7-14 relate to a sensor unit formed to be associated with the base of various off-the-shelf bag racks, or formed into a unitary custom rack unit. A separable display/input unit is provided, as will be further discussed below.

Referring to FIGS. 7-9 and 11, an exemplary bag rack R for supporting a pack or stack of bags 171 in generally uniform registration is provided, the rack having a base 211 and vertical supports 173, 173′, the vertical supports having generally horizontally disposed, spaced horizontal support members 174, 174′ for supporting the an open bag B for filling over the base 211. A sensor S unit is associated with the base (could be mounted upon, situated thereunder, or integrated into the bag rack base), and may be in the form of a strain gauge load cell C or the like situated between a base 212 and platter 151 as in known scale configurations, or other weight sensor or pressure switch, which communicates data on the load to a control unit/console 213. While the control unit/console 213 is shown adjacent to the sensor S unit, it is noted that the control unit/console is removeable from the sensor S unit and is repositionable, and may communicate with the sensor S unit via wire or wireless (RF or IR, for example).

In use, the next bag B to be dispensed from the stack is typically opened 112 on the rack so that the handles of the bag are supported with the mouth of the bag in an open position by supports 174, 174′, then filled 113 with product, for example, during a check out procedure at a retail establishment or grocery store.

As the opened bag B′ is filled 113 with product P, P′, the strain gauge C or other load or weight sensor or switch detects the weight variations applied thereupon and relays data on the load to the control unit 213, which includes a CPU and memory and which displays, via bag content weight display 189, the bag weight in real time during filling. Also displayed is product count per bag via product count display 159, utilizing a electronic scale counting function which may be implemented in a computer associated with the unit. For example, incremental increases in weight on the sensor with a predetermined dwell time can be counted as product.

With such a counting routine, there should be established a minimum interval (for example, 0.5 seconds) where the weight must be steady on the sensor before being counted, to avoid a bump on the scale being registered as a count. Further, data on any predetermined incremental increase in weight sensed by said weight sensor from the period said bag is opened until the maximum weight in said incremental increase is detected before said increase in weight is no longer detected as said bag is removed from the rack, can be used to calculate the bag load weight for said filled bag

The bag weight display may include, in addition to the weight, an up arrow or the like to indicate to the operator to continue filling, or a down arrow or the like to indicate remove product due to overfilling. A display could be used to designate an under filled bag, a bag filled within the targeted fill weight specification, or an over filled bag. Upon the bag reaching a pre-designated optimal weight, the weight display may alternatively change color or other indication may be provided such as an indicator bar 111, which informs the operator that the bag has been optimally packed.

The operator may then remove the filled bag, which results the sensor sensing the decrease in load back to zero, which event can be used by the computer to count the loaded bag, and display the loaded bag count at display 214.

A data input/output (I/O) interface 110 is provided to allow remote monitoring, data compilation, or control of the system. Also, the interface 110 may integrate with the operator's cash register or network to provide feedback and data on each transaction of the operator.

As discussed in my earlier '317 application, the bagging data from the sensor S unit (via pressure, weight or other sensor) can be utilized “for verification of proper filling of the bags by the party operating the checkout counter”, as well as for providing bag count information on the number of bags utilized per bagger and average weight of each bag (to discern wasteful use by the bagger, for example), as well as for other uses such as inventory control, calculation of bag deposit, RFID tracking, etc.

In addition to the above indicated displays, the control unit/console 213 may also include a numerical input pad 169 which can be used for a number of functions, including, for example, customizing optimal bag weight parameters (which can vary depending upon the type of bag, product being loaded, thickness of bag, etc), input operator ID, diagnostic and calibration functions, time and date, type of bag, location or other identification relating to the checkout stand utilized with the rack, calculating a deposit on the bags (as discussed above), etc.

Counter control buttons 179 may be provided to display data such as bags per operator shift, average bags per customer, accumulated bags used since last reset, etc. This data may be stored in memory for transmission via wireless or wired network, or other means to a central computer for analysis. Also, a display can be used to display average contents per bag, average weight per bag, etc. Accordingly, the numerical keyboard or input pad 16 could be utilized to set the appropriate weight specifications for the bag.

Once a scale has been loaded with a predesignated minimum weight, for example, 0.25 ounces, any reduction on the sensor to zero could be counted as a bag being removed from the rack with product, and added to the bag count. At the beginning of the shift, the operator would log in via the input pad 169, which is associated with bagging data until the operator logs out via pad 169 at the end of the shift. The data, which could include bag count, product count per bag, operator ID, shift log in time/date, log out time, date, average weight of bags, bags under designated minimum load, bags over designated maximum load, and average product per bag, and, with a timer circuit, even average load time per bag and average checkout time per product or customer could provided and be saved into memory.

A USB port 133 may be provided to as a data I/O interface to download data from the control unit/console 213 for uploading to a central computer. The downloaded data may be in spreadsheet format, ASCII comma delimited or other format. A USB drive 131 may be inserted 132 into the USB port 133 to download data on the bag count as well as other data, which data may then be uploaded to a central computer for use in monitoring operator performance and bagging statistics associated with that checkout stand.

With an establishment having multiple check out stands with the device of the present invention provided at each, a single USB drive can be used to download data from each of the units. In such a scenario, each uploaded file would have its own individual designation to identify the checkout stand associated with the file. The compiled data could then be uploaded into a spreadsheet or other software to obtain a better understanding of the data.

An alternative interface could be a RS-232 plug, a network plug, or the like. In addition to the USB drive, other storage or transmission means could be plugged into the USB port, such as a wifi adapter or wireless access point to convey the data.

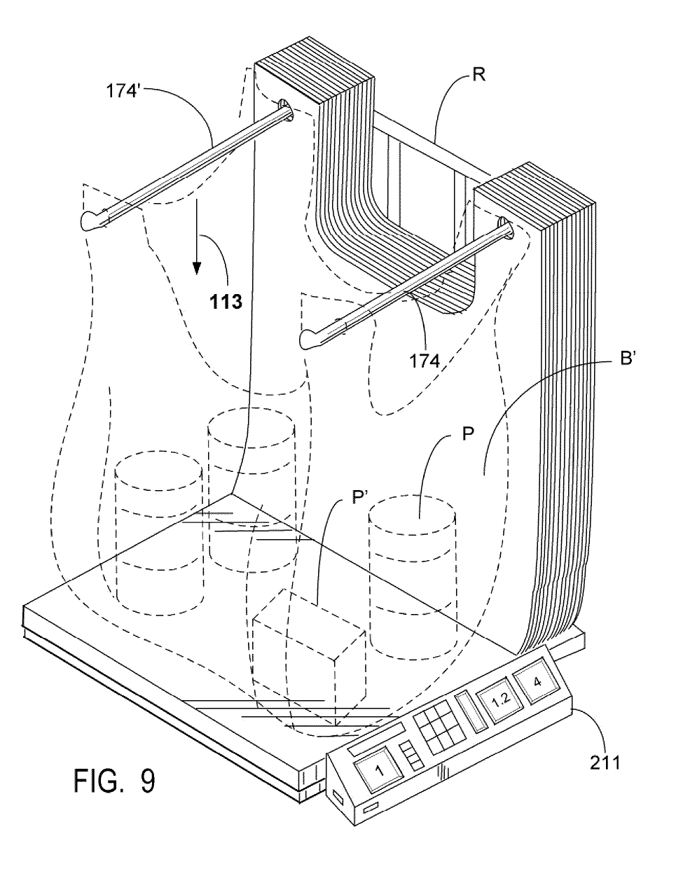

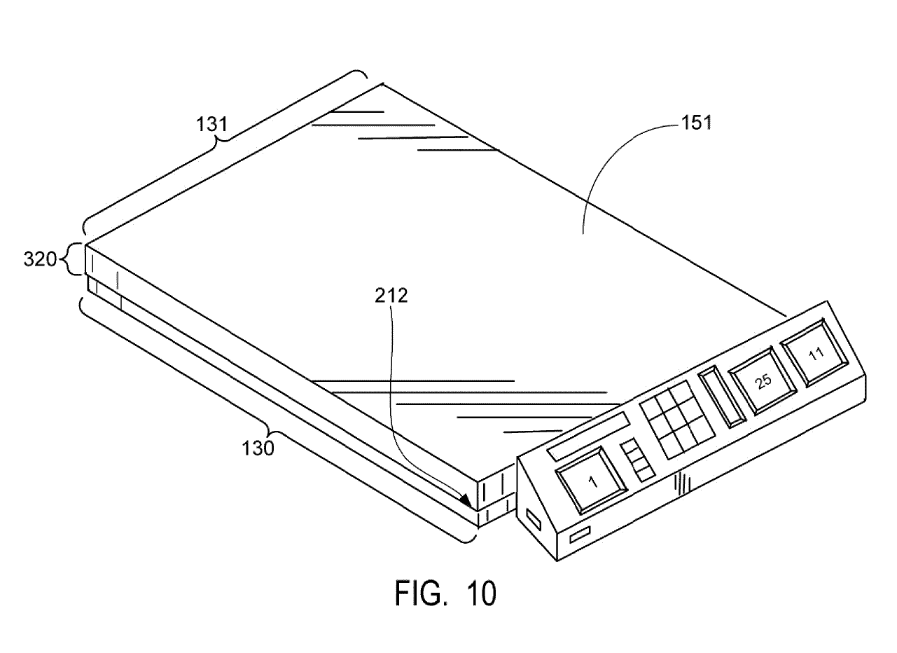

FIGS. 9 and 10 illustrate the sensor unit having platter 151 (which may be supported by the sensor, for example, a strain gauge sensor) upon the sensor base 212 having a width 130 and a depth 131 and nominal height 320 sized to fit under an open bag B supported by the rack 174, 174′ horizontal support members, on an off-the-shelf rack R. As indicated, the sensor unit ideally requires a low profile to occupy the space above the rack base and under the bottom of the bag supported by the handle supports of the rack, where the open bag would rest during filling, with nominal interference to the normal use of the rack/bagging system. The sensor base 212 ideally would be affixed to the rack via a bracket or the like, which could interface with the rack itself, or be affixed to the rack base 211. The mount could be permanent for use on a continuous basis in a checkout operation, or could be a temporary mount for training and/or evaluation purposes.

The sensor unit, if in the form of a strain gauge sensor with computer, input and display as discussed above, or other scale unit, could be battery powered and should have the capacity to run for at least three months between battery charges, or it could be rechargeable or utilize AC power.

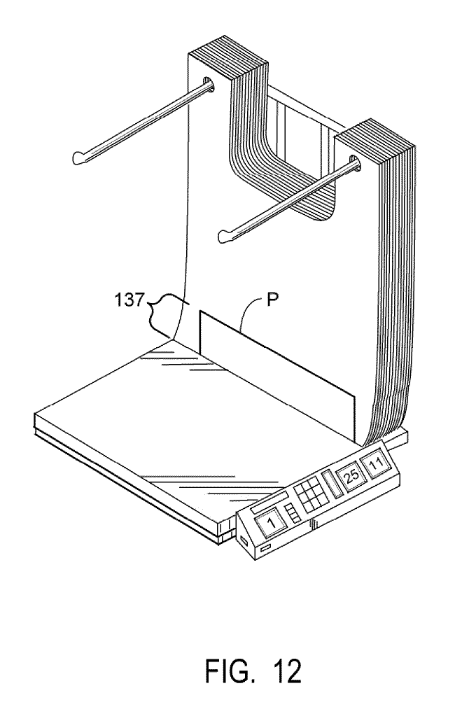

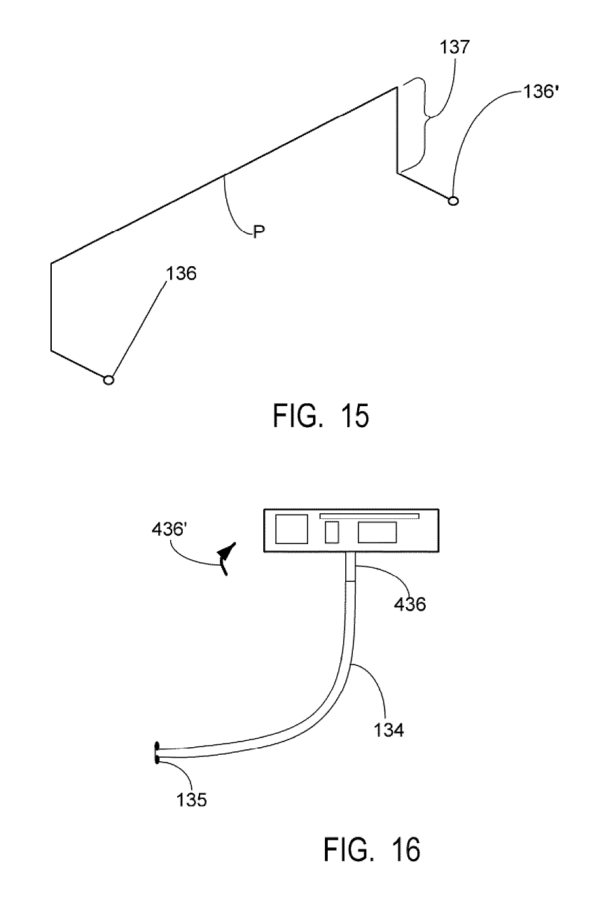

In order to prevent the unopened bags forming the bag stack from engaging the platter and causing a false reading, a partition may be provided. As shown in FIGS. 12-15, an exemplary partition P comprises a wire rod having first 136 and second 136′ ends having apertures formed therein for attachment (via threaded fasteners, for example) to the underside of the sensor base 212, each end of the partition extending from the underside of the platter unit to the extend vertically 137 a distance above the platter unit (for example, about 2-3 inches above the platter) to form a partition wall between the lower portion of the opened bag above the platter and the stack of bags supported by the rack. In preparing a bag for dispensing, the operator would pull 112 the bag to be dispensed B away from the bag pack so that the lower portion of the bag to be dispensed passes over the partition and is situated above the sensor base, at which point the bag mouth is opened and the bag B is supported in an open position for filling by the horizontal supports of the rack.

FIG. 16 illustrates an alternative console which is supported by a gooseneck 134 which has a flange 135 or other mounting means at its distal end to mount to the platter unit, the gooseneck allowing the console to be positioned in various diverse positions to accommodate installation in various different locations or rack configurations. Console engages a pivotal sleeve 436 to allow rotational positioning 436′ of the console. The sleeve may be configured to engage a bracket for mounting to the associated bag rack for support.

It is noted that the proximity switches, light sensors, sonic sensors, and other means can be provided to accomplish the counting and monitoring functions of the present invention, and that the detailed example provided is not intended to be limiting.

The invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

What is claimed is:

1. The method of determining the amount of grocery bags utilized in carrying product in a retail transaction, comprising the steps of:
a) providing a bag stack comprising a plurality of bags removably affixed to one another in uniform registration to form a bag stack,
b) providing a bag rack comprising a base and a vertical support, said base having associated therewith a sensor;
c) mounting said bag stack upon said bag rack such that said bag stack is supported by said rack;
d) opening a bag from said bag stack upon said rack so that the bottom of said bag is adjacent to said sensor, then placing product inside said bag;
e) allowing said product to apply pressure to said sensor, and utilizing said pressure to detect added product in said bag, so as to provide sensor detection and communicating same to a computer;
f) removing said bag with product from said rack;
g) using said sensor to detect removal of said pressure, and communicating same to said computer, providing sensor data;
h) said computer utilizing said sensor data to count said bag with product as being removed from said rack, so as to provide a bag count;
I) repeating steps d-h until said retail transaction is complete, providing a final bag count; and
j) associating said final bag count with said transaction.

2. The method of claim 1, wherein in step “b” said sensor further comprises a pressure switch associated with said base of said rack.

3. The method of claim 1, wherein in step “b” said sensor comprises a strain gauge sensor.

4. The method of claim 1, wherein in step “b” said sensor comprises a switch.

5. The method of claim 1, wherein in step “b” there is provided the additional step “b1” of providing an input interface for inputting data associated with the retail transaction.

6. The method of claim 5, wherein following step “b1” there is provided the additional step “b2” of utilizing said input interface to input data relating to the operator, time, and location of the bag rack.

7. The method of claim 5, wherein in step “b” said sensor comprises a weight sensor, and wherein there is further provided the additional step of compiling data on any predetermined incremental increase in weight sensed by said weight sensor from the period said bag is opened until the maximum weight in said incremental increase is detected before said increase in weight is no longer detected as said bag is removed from the rack, providing the bag load weight for said filled bag.

8. The method of claim 7, wherein in step “f” said bag count is generated by said sensor detecting said bag load being removed therefrom.

9. The method of claim 8, wherein said data on said incremental increase in weight sensed by said weight sensor in step “e” is compiled.

10. The method of claim 9, wherein said incremental increase is compiled for use in counting product being loaded in said bag.

11. The method of claim 10, wherein there is provided an minimum interval of time before said incremental increase is counted as product.

12. The method of claim 11, wherein said sensor detects an incremental decrease in weight to count removal of product from said bag.

13. The method of claim 10, wherein there is provided a data interface for transferring data from said computer.

14. The method of claim 13, wherein said data interface comprises a USB port.

15. The method of claim 14, wherein there is further provided the step “k” following step “j” communicating, via said data interface, said data compiled from said sensor, and utilizing said data to calculate the bags used per transaction, average weight of product in each of bags used, the average number count of product in the bags, and the operator associated, the reporting period, and the operator associated with the reporting period.

16. The method of claim 15, wherein said input interface is situated in a housing having a display, and said display communicates to the operator information on the bag load.

17. The method of claim 16, wherein there is provided the added step “h1” following step “h” of utilizing said sensor determine the status of said bag as it is being loaded with regard to optimal bag load weight, and communicating to the operator instructional information regarding the loading of said bag so as to provide a filled bag within said optimal bag load weight.

18. The method of claim 1, wherein after step “c” there is provided the additional step “c1” of providing a vertical partition having first and second sides, said vertical partition situated between said sensor and said bag stack, and wherein there is provided in step “d” the added step “dd” of positioning said bag being opened on one side of said partition with said bag stack positioned on said second side of said partition prior to filling said bag, so as to separate said bag being opened from said bag stack to engage said sensor, while preventing said bag stack from engaging said sensor.

19. A system for tracking thermoplastic bags at a retail establishment having a checkout area, comprising:
a rack formed to dispense a plurality of bags removeably affixed to one another in uniform registration in the form of a bag stack;
said rack having a base, said base being formed to support a bag load;
said rack being formed to support a bag for loading in an open position over said base; and a sensor associated with said base;
whereby, upon opening and filling a bag from said bag stack, a bag load is placed upon said base such that said sensor is formed to detect and compile increases in said bag load until said bag is filled and removed, providing sensor data for utilization in determining a bag count.

20. The system of claim 19, wherein said sensor is a strain gauge sensor and wherein there is further provided a computer to utilize said sensor data to determine a count of bags used in a transaction.

21. The system of claim 19, wherein said sensor is a pressure sensor and wherein there is further provided a computer to utilize said pressure sensor data to determine a count of bags used in a transaction.

22. The system of claim 19, wherein there is further provided a vertical partition situated between said sensor and said bag stack on said rack, said partition separating an opened bag for loading from said bag stack, while isolating said bag stack from said sensor.

23. A method of determining the amount of grocery bags utilized in a retail transaction, comprising the steps of:
a) providing a bag stack comprising a plurality of bags removably affixed to one another in uniform registration,
b) providing a bag rack comprising a base and a vertical support, said base having associated therewith a sensor, and said base;
c) mounting said bag stack upon said bag rack such that said bag stack is supported in substantially vertical orientation by said rack;
d) opening a bag from said bag stack upon said rack, providing an open bag;
e) placing product in said open bag, providing a bag load,
f) utilizing said base to support said bag load; while utilizing said sensor to detect said bag load,
g) repeating steps e and f until said bag is filled with the desired amount of product; while
h) utilizing said sensor to detect the removal of said bag load as said bag is removed from said rack, so as to provide sensor detection;
I) communicating said sensor detection to a computer, said computer utilizing said sensor detection to count said bag, so as to provide a bag count;
j) repeating steps d-I until said retail transaction is complete, providing a final bag count; and
k) associating said final bag count with said transaction, providing transaction data.

24. The method of claim 23, wherein there is provided the added step “l” after step “k” of uploading said transaction data to a central computer.

25. The method of claim 24, wherein there is provided the added step “m” after step “l” of utilizing said central computer to analyze said transaction data, and reporting on same.
